(19) United States
(12) Patent Application Publication
(10) Pub. No.: US 2011/0032159 A1
(43) Pub. Date: Feb. 10, 2011

(54) Antenna Apparatus with Adaptive Polarization Switching Function

(76) Inventors: Min-Chung Wu, Taoyuan County (TW); Shao-Chin Lo, Miaoli City (TW)

Correspondence Address: NORTH AMERICA INTELLECTUAL PROPERTY CORPORATION, P.O. BOX 506, MERRIFIELD, VA, 22116, US

(21) Appl. No.: 12/849,822

(22) Filed: Aug. 4, 2010

(30) Foreign Application Priority Data
Aug. 4, 2009 (TW) 098126143
Jan. 7, 2010 (TW) 099100265

(51) Int. Cl. H01Q 21/24; H01Q 1/24

(52) U.S. Cl. 343/702; 343/893

(57) ABSTRACT

An antenna device with an adaptive polarization switching function, the antenna device including an antenna array comprising a first linear polarization antenna and a second linear polarization antenna, the first linear polarization antenna and the second linear polarization antenna having polarization directions orthogonal to each other, and a feeding unit comprising an input terminal for receiving a transmission signal, a first output terminal coupled to the first linear polarization antenna, and a second output terminal coupled to the second linear polarization antenna, wherein the feeding unit distributes energy of the transmission signal to the first output terminal and the second output terminal according to a control signal so as to generate feeding signals of the first linear polarization antenna and the second linear polarization antenna and to make the feeding signals have a phase difference.

### BACKGROUND OF THE INVENTION

1. Field of the Invention

The present invention relates to an antenna device with an adaptive polarization switching function, and more particularly, to an antenna device that switches polarization directions by adjusting energy proportion and phase difference of signals outputted to two linear polarization antennas.

2. Description of the Prior Art

An electronic product with a wireless communication function, such as laptop, PDA (Personal Digital Assistant), etc, radiates and receives radio waves via antennas, to transmit or exchange radio signals, so as to access a wireless network. Hence, for enabling users to access the wireless network in a more convenient way, a bandwidth of an ideal antenna should be as large as possible within limitations, whereas a size thereof should be as small as possible to meet requirements of compact size electronic products.

In addition, with development of wireless communication techniques, quantity of antennas equipped within an electronic product may increase. For example, wireless local area network (WLAN) standard IEEE 802.11n supports multi-input multi-output (MIMO) communication technique, that is, a related electronic product may receive and transmit radio signals via multiple sets of antennas simultaneously, to largely increase data throughput and transmission distance without increasing bandwidth or transmit power expenditure, such that spectrum efficiency and data rate of a wireless communication system can be effectively enhanced, and communication quality can be improved as well.

In the prior art, each antenna in a MIMO system has a fixed polarization direction, and is unable to be adjusted based on system requirements. Under such circumstances, the antennas of transmitting terminals and receiving terminals may have polarization loss due to polarization mismatch, which results in poor transmission efficiency.

On the other hand, regarding a MIMO system adopting a polarization diversity technique, if multiple sets of antennas are able to adequately adjust their polarization directions based on circumstances of transmission environment, for minimizing polarization loss of each antenna, effect of polarization diversity can be optimized so as to achieve highest transmission efficiency.

### SUMMARY OF THE INVENTION

It is therefore a primary objective of the claimed invention to provide an antenna device with an adaptive polarization switching function.

The present invention discloses an antenna device with an adaptive polarization switching function. The antenna device includes an antenna array and a feeding unit. The antenna array includes a first linear polarization antenna and a second linear polarization antenna. The first linear polarization antenna and the second linear polarization antenna have polarization directions orthogonal to each other. The feeding unit includes an input terminal for receiving a transmission signal, a first output terminal coupled to the first linear polarization antenna, and a second output terminal coupled to the second linear polarization antenna. The feeding unit distributes energy of the transmission signal to the first output terminal and the second output terminal according to a control signal so as to generate feeding signals of the first linear polarization antenna and the second linear polarization antenna and to make the feeding signals have a phase difference.

The present invention further discloses a wireless device, including an antenna array, a feeding unit and a signal processing unit. The antenna array includes a first linear polarization antenna and a second linear polarization antenna. The first linear polarization antenna and the second linear polarization antenna have polarization directions orthogonal to each other. The feeding unit includes an input terminal for receiving a transmission signal, a first output terminal coupled to the first linear polarization antenna, and a second output terminal coupled to the second linear polarization antenna. The feeding unit distributes energy of the transmission signal to the first output terminal and the second output terminal according to a control signal so as to generate feeding signals of the first linear polarization antenna and the second linear polarization antenna according to a control signal and to make the feeding signals have a phase difference. The signal processing unit is utilized for generating the transmission signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an antenna device with an adaptive polarization switching function according to the present invention.

FIG. 2 is a schematic diagram of operations of the feeding unit in FIG. 1.

FIG. 3 is a schematic diagram of the antenna array in FIG. 1.

FIG. 4 is a schematic diagram of a wireless device according to an embodiment of the present invention.

FIG. 5 is a schematic diagram of a wireless device according to another embodiment of the present invention.

### DETAILED DESCRIPTION

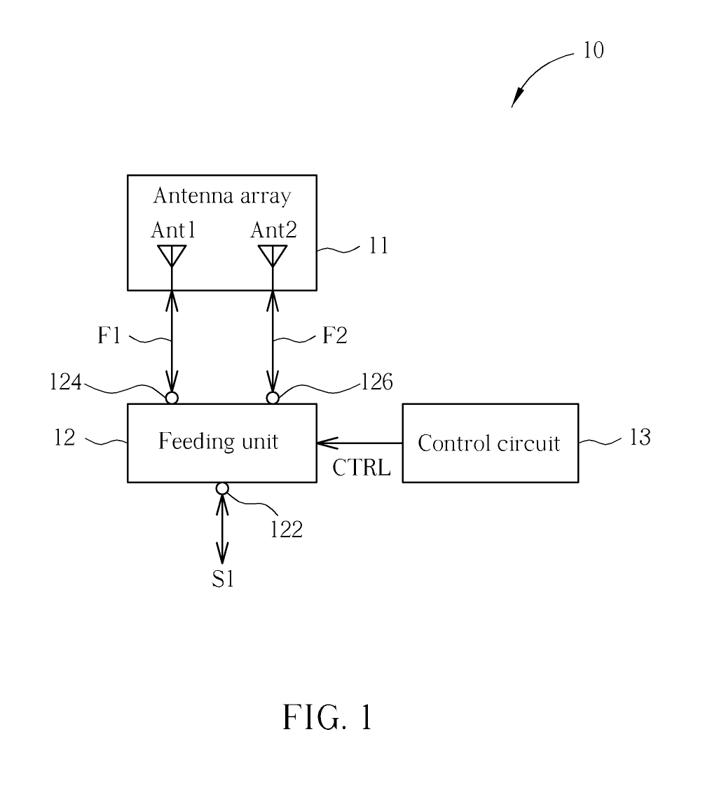

Please refer to FIG. 1. FIG. 1 shows an antenna device 10 with an adaptive polarization switching function according to an embodiment of the present invention. The antenna device 10 is utilized for performing reception and transmission of radio signals, and includes an antenna array 11 and a feeding unit 12. The antenna array 11 includes linear polarization antennas Ant1 and Ant2 having polarization directions orthogonal to each other. The feeding unit 12 includes an input terminal 122 and output terminals 124 and 126. The input terminal 122 is utilized for receiving a transmission signal S1, and the output terminals 124 and 126 are coupled to the linear polarization antennas Ant1 and Ant2 of the antenna array 11, respectively. The feeding unit 12 distributes energy of the transmission signal S1 to the output terminals 124 and 126 according to a control signal CTRL, so as to generate feeding signals F1 and F2 of the linear polarization antenna Ant1 and Ant2, and to make the feeding signals F1 and F2 have a phase difference. In addition, the antenna device 10 further includes a control circuit 13, coupled to the feeding unit 12, for generating the control signal CTRL.

According to the embodiment of the present invention, the feeding unit 12 adjusts energy proportions of the transmission signal S1 outputted to the linear polarization antenna Ant1 and the linear polarization antenna Ant2, respectively, and phase differences thereof according to a logic state of the control signal CTRL. As a result, the antenna array 11 is able to generate electric fields of various polarization directions by the two linear polarization antennas Ant1 and Ant2 having polarization directions orthogonal to each other. Detailed operations of the antenna device 10 are as follows.

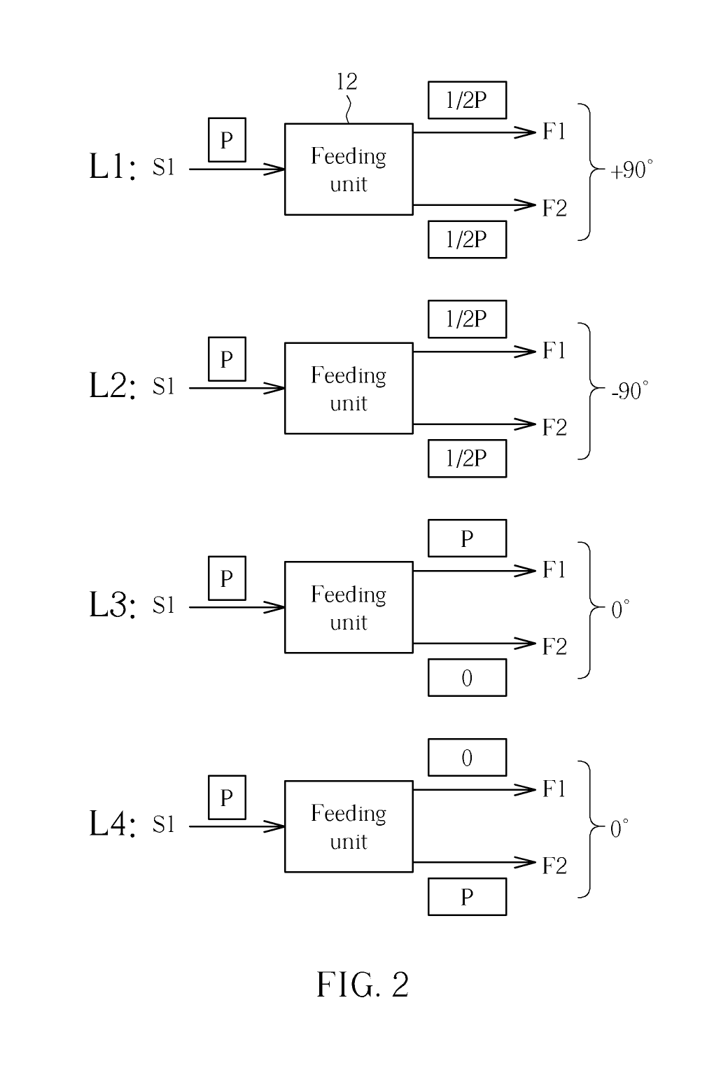

Please refer to FIG. 2. FIG. 2 is a schematic diagram of operations of the feeding unit 12 in FIG. 1. According to the embodiment of the present invention, the feeding unit 12 adjusts the energy proportion of signals outputted to the output terminal 124 and the output terminal 126 and the phase difference thereof according to the logic state of the control signal CTRL. For example, the control circuit 13 may generate control signals of four logic states L1-L4, while the feeding unit 12 may provide signals of different energy proportions and phase differences to the output terminals 124 and 126 according to the logic states L1-L4. Assume that P denotes energy of the transmission signal S1, as illustrated in FIG. 2. In the logic state L1, the feeding signals F1 and F2 are of equal energy, which are half of the energy of transmission signal s1, and the feeding signal F1 has a 90-degree phase lead to the feeding signal F2; in the logic state L2, the feeding signals F1 and F2 are also of equal energy, which are half of the energy of transmission signal s1, and the feeding signal F1 has a 90-degree phase lag behind the feeding signal F2; in the logic state L3, energy of the feeding signal F1 is equal to the energy of transmission signal S1, and energy of the feeding signal F2 is 0; on the contrary, in the logic state L4, the energy of the feeding signal F2 is equal to the energy of the transmission signal S1, and the energy of the feeding signal F1 is 0.

Note that the above energy distribution is ideal, that is, an energy sum of the feeding signals F1 and F2 is equal to the energy of the transmission signal S1. In practice, the feeding unit 12 causes expenditure of input energy, causing the energy sum of the feeding signals F1 and F2 smaller than the energy of the transmission signal S1. However, as long as the energy proportion of the feeding signal F1 to the feeding signal F2 and the phase difference thereof can be controlled within allowable ranges, the objective of the present invention can still be achieved. In addition, a quantity of the logic states generated by the control circuit 13 is determined by design of the feeding unit 12. Certainly, in other embodiments, the feeding unit 12 may also generate the feeding signals F1 and F2 of various energy proportions and phase differences according to other logic states of the control signal CTRL, and is not limited to these.

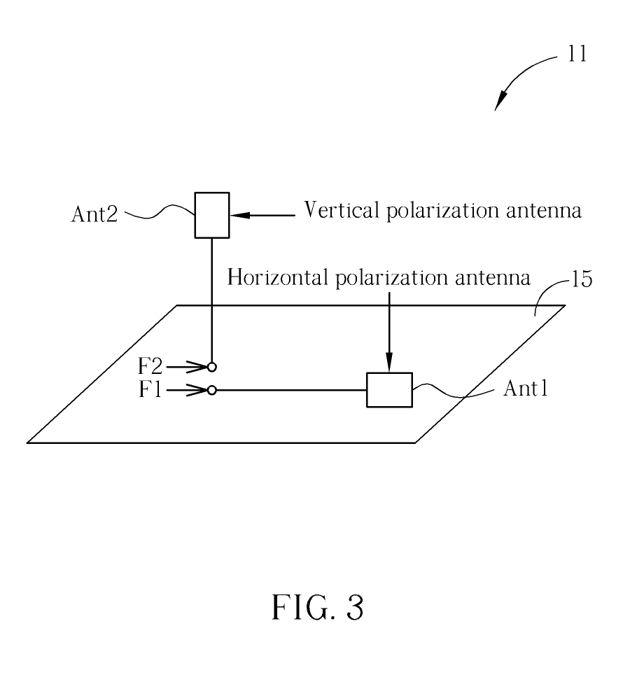

In FIG. 1, the horizontal polarization antenna Ant1 and the vertical polarization antenna Ant2 included in the antenna array 11 are merely denoted by simple symbols. In practice, as illustrated in FIG. 3, the horizontal polarization antenna Ant1 and the vertical polarization antenna Ant2 can be implemented by two identical linear polarization antennas, and be disposed on a horizontal substrate 15 and a vertical substrate (not shown in FIG. 3) orthogonally combined with each other. Therefore, on the premise that the feeding signals F1 and F2 have the same energy, the horizontal polarization antenna Ant1 and the vertical polarization antenna Ant2 can provide a horizontal polarization electric field and a vertical polarization electric field of same energy, respectively.

Under such circumstances, the antenna array 11 may provide electric fields of various polarization directions according to the way of feeding signal to fulfill requirements of wireless communication systems. For example, if energy of the feeding signal F1 of the horizontal polarization antenna Ant1 is approximately equal to that of the feeding signal F2 of the vertical polarization antenna Ant2, and the feeding signal F1 has a 90-degree phase lead to the feeding signal F2, i.e. corresponding to the logic state L1 in FIG. 2, a right-hand circular polarization electric field is generated; if the energy of the feeding signals F1 and F2 are identical, and the feeding signal F1 has a 90-degree phase lag behind the feeding signal F2, i.e. corresponding to the logic state L2 in FIG. 2, a left-hand circular polarization electric field is generated; if the signals are only fed to the horizontal polarization antenna Ant1, rather than the vertical polarization antenna Ant2, i.e. corresponding to the logic state L3 in FIG. 2, the antenna array 11 generates a horizontal polarization electric field; similarly, if the signals are only fed to the vertical polarization antenna Ant2, rather than the horizontal polarization antenna Ant1, i.e. corresponding to the logic state L4 in FIG. 2, the antenna array 11 generates a vertical polarization electric field.

Certainly, the antenna device 10 may further adjust the phases and amplitudes of the feeding signals of the horizontal polarization antenna Ant1 and the vertical polarization antenna Ant2 according to practical requirements, to generate various linear polarization or elliptical polarization electric fields. For example, if the horizontal polarization antenna Ant1 and the vertical polarization antenna Ant2 have the feeding signals of same amplitude and no phase difference, the antenna array 11 may generate a 45-degree polarization direction electric field. Such variation is within the scope of the present invention.

As a result, the antenna device 10 of the present invention may dynamically adjust the polarization directions of the radiation field according to the circumstances of the radio environment, so to decrease the polarization loss and enhance the transmission efficiency.

Note that, the above-mentioned horizontal polarization antenna Ant1 and vertical polarization antenna Ant2 can be implemented by linear polarization antennas of any formats, such as monopole antenna, dipole antenna, Yagi antenna, and planar inverted-F antenna, and is not limited to these. The feeding unit 12 can be implemented by any 1-input 2-output radio circuit systems with the energy distribution function, such as a combination of 3 dB coupler and switches. Those implementations are all within the scope of the present invention.

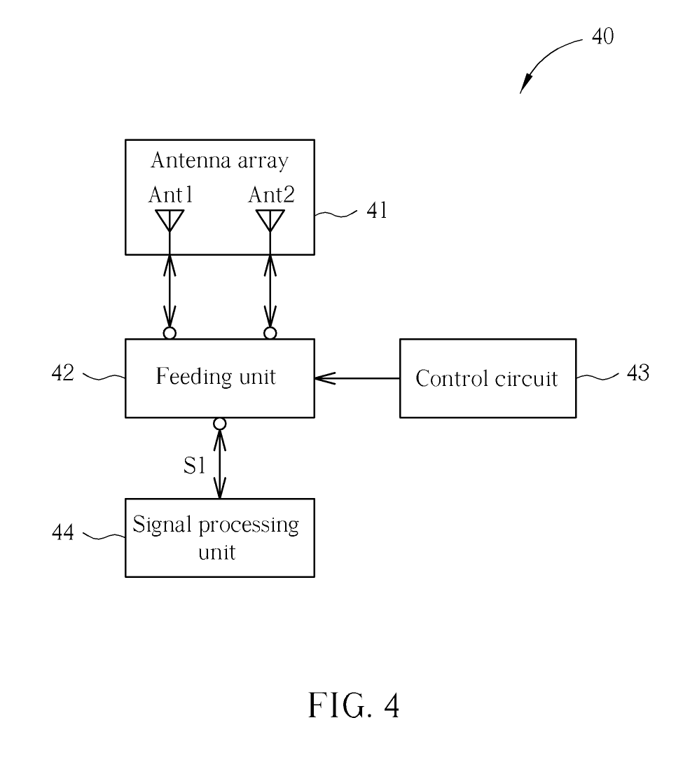

Please refer to FIG. 4. FIG. 4 is a schematic diagram of a wireless device 40 according to an embodiment of the present invention. The wireless device 40 can be any wireless device with antennas, such as a WLAN device or a mobile phone, and is not limited to these. The wireless device 40 includes an antenna array 41, a feeding unit 42, a control circuit 43 and a signal processing unit 44. The antenna array 41, the feeding unit 42, and the control circuit 43 constitute the antenna device 10 in FIG. 1, and the operations thereof are detailed in the above and thus omitted herein. The signal processing unit 44 is used for generating the transmission signal S1, such as a packet data to be transmitted to WLAN. As a result, by switching the polarization direction of the antenna, the wireless device 40 decreases the polarization loss of the transmission signal S1, so as to enhances the transmission efficiency.

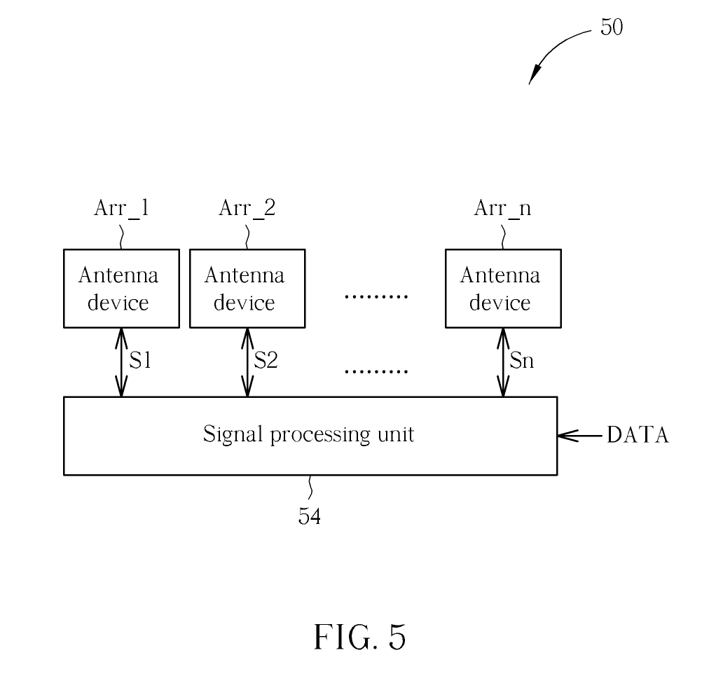

In addition, the antenna device 10 can also be implemented in a wireless device using MIMO technique, such as a wireless device complying with IEEE 802.11n standard, so as to utilize the polarization diversity technique to increase signal transmission channels, decrease multi-path fading, and enhance the transmission efficiency. Please refer to FIG. 5. FIG. 5 is a schematic diagram of a wireless device 50 according to another embodiment of the present invention. The wireless device 50 includes multiple sets of antenna devices Arr_1-Arr_n and a signal processing unit 54. Each of the antenna devices Arr_1-Arr_n is implemented by the antenna device 10 in FIG. 1, and is capable of dynamically adjusting the polarization directions of the radiation fields. Under such circumstances, the signal processing unit 54 generates transmission signals S1-Sn of each antenna device according to data to be transmitted DATA, for allowing the antenna devices Arr_1-Arr_n to perform transmission in different polarization directions. Therefore, the wireless device 50 may utilize the polarization diversity method to enhance the performance of a MIMO system.

To sum up, the present invention provides an antenna system for the MIMO system, which is capable of switching the polarization directions of the antenna radiation field (including the horizontal linear polarization, the vertical linear polarization, the right-hand circular polarization and the left-hand circular polarization) according to amplitudes and directions of spatial noise, so as to utilize the adaptive polarization switching method to achieve the best transmission efficiency.

Those skilled in the art will readily observe that numerous modifications and alterations of the device and method may be made while retaining the teachings of the invention.

What is claimed is:

1. An antenna device with an adaptive polarization switching function, the antenna device comprising:
an antenna array comprising a first linear polarization antenna and a second linear polarization antenna, the first linear polarization antenna and the second linear polarization antenna having polarization directions orthogonal to each other; and
a feeding unit comprising an input terminal for receiving a transmission signal, a first output terminal coupled to the first linear polarization antenna, and a second output terminal coupled to the second linear polarization antenna, wherein the feeding unit distributes energy of the transmission signal to the first output terminal and the second output terminal according to a control signal so as to generate feeding signals of the first linear polarization antenna and the second linear polarization antenna and to make the feeding signals have a phase difference.

2. The antenna device of claim 1, wherein the first linear polarization antenna and the second linear polarization antenna are a horizontal polarization antenna and a vertical polarization antenna, respectively.

3. The antenna device of claim 1, wherein the feeding unit adjusts an energy proportion of the feeding signal of the first linear polarization antenna to the feeding signal of the second linear polarization antenna and the phase difference thereof according to a logic state of the control signal.

4. The antenna device of claim 1, wherein an energy sum of the feeding signal of the first linear polarization antenna and the feeding signal of the second linear polarization antenna is approximately equal to energy of the transmission signal.

5. The antenna device of claim 1, wherein the feeding signal of the first linear polarization antenna and the feeding signal of the second linear polarization antenna are of equal energy, and the feeding signal of the first linear polarization antenna has a 90-degree phase lead to the feeding signal of the second linear polarization antenna.

6. The antenna device of claim 1, wherein the feeding signal of the first linear polarization antenna and the feeding signal of the second linear polarization antenna are of equal energy, and the feeding signal of the first linear polarization antenna has a 90-degree phase lag behind the feeding signal of the second linear polarization antenna.

7. The antenna device of claim 1, wherein energy of the feeding signal of the first linear polarization antenna is approximately equal to energy of the transmission signal, while energy of the feeding signal of the second linear polarization antenna is 0.

8. The antenna device of claim 1, wherein energy of the feeding signal of the second linear polarization antenna is approximately equal to energy of the transmission signal, while energy of the feeding signal of the first linear polarization antenna is 0.

9. The antenna device of claim 1, wherein the antenna array generates electric fields of various polarization directions according to the energy proportion of the feeding signal of the first linear polarization antenna to the feeding signal of the second linear polarization antenna energy and the phase difference thereof.

10. The antenna device of claim 1 further comprising a control circuit, coupled to the feeding unit, for generating the control signal.

11. A wireless device, comprising:
an antenna array comprising a first linear polarization antenna and a second linear polarization antenna, the first linear polarization antenna and the second linear polarization antenna having polarization directions orthogonal to each other;
a feeding unit comprising an input terminal for receiving a transmission signal, a first output terminal coupled to the first linear polarization antenna, and a second output terminal coupled to the second linear polarization antenna, wherein the feeding unit distributes energy of the transmission signal to the first output terminal and the second output terminal according to a control signal so as to generate feeding signals of the first linear polarization antenna and the second linear polarization antenna according to a control signal and to make the feeding signals have a phase difference; and
a signal processing unit, for generating the transmission signal.

12. The wireless device of claim 11, wherein the first linear polarization antenna and the second linear polarization antenna are a horizontal polarization antenna and a vertical polarization antenna respectively.

13. The wireless device of claim 11, wherein the feeding unit adjusts an energy proportion of the feeding signal of the first linear polarization antenna to the feeding signal of the second linear polarization antenna and the phase difference thereof according to a logic state of the control signal.

14. The wireless device of claim 11, wherein an energy sum of the feeding signal of the first linear polarization antenna and the feeding signal of the second linear polarization antenna is approximately equal to energy of the transmission signal.

15. The wireless device of claim 11, wherein the feeding signal of the first linear polarization antenna and the feeding signal of the second linear polarization antenna are of equal energy, and the feeding signal of the first linear polarization antenna has a 90-degree phase lead to the feeding signal of the second linear polarization antenna.

16. The wireless device of claim 11, wherein the feeding signal of the first linear polarization antenna and the feeding signal of the second linear polarization antenna are of equal energy, and the feeding signal of the first linear polarization antenna has a 90-degree phase lag behind the feeding signal of the second linear polarization antenna.

17. The wireless device of claim 11, wherein energy of the feeding signal of the first linear polarization antenna is approximately equal to energy of the transmission signal, while energy of the feeding signal of the second linear polarization antenna is 0.

18. The wireless device of claim 11, wherein energy of the feeding signal of the second linear polarization antenna is approximately equal to energy of the transmission signal, while energy of the feeding signal of the first linear polarization antenna is 0.

19. The wireless device of claim 11, wherein the antenna array generates electric fields of various polarization directions according to the energy proportion of the feeding signal of the first linear polarization antenna to the feeding signal of the second linear polarization antenna energy and the phase difference thereof.

20. The wireless device of claim 11 further comprising a control circuit, coupled to the feeding unit, for generating the control signal.

21. The wireless device of claim 11, wherein the wireless device is utilized in a MIMO wireless communication system.
